(19) United States
(12) Patent Application Publication
(10) Pub. No.: US 2010/0113266 A1
(43) Pub. Date: May 6, 2010

(54) MERCURY ADSORBENT AND PROCESS FOR PRODUCTION THEREOF

(75) Inventors: Susumu Abe, Okayama-ken (JP); Tetsuya Hanamoto, Okayama-ken (JP); Yoshifumi Egawa, Okayama-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kuraray Chemical Co. Ltd., Bizen-shi, Okayama-ken (JP)

(21) Appl. No.: 12/528,457

(22) PCT Filed: May 26, 2008
(86) PCT No.: PCT/JP2008/059620

§ 371 Date: Sep. 17, 2009

(30) Foreign Application Priority Data
May 29, 2007 (JP) 2007-141742

(51) Int. Cl. C01B 31/08

(52) U.S. Cl. 502/416

(57) ABSTRACT

The invention aims at providing a mercury adsorbent which is optimized in base activated carbon, sulfur amount carried, and heat treatment conditions, and is enhanced in mercury adsorption performance, and a process for producing the adsorbent, which can be put into industrial practice advantageously. The aim is attained by a mercury adsorbent made up of sulfur-carried activated carbon, with which sulfur is carried on activated carbon and which exhibits a sulfur peak top of the temperature of sulfur desorption at 534° C. to 537° C. in a calorimetric curve measured by a differential scanning calorimeter at a temperature rise rate of 10° C./minute under a nitrogen atmosphere, and a process for production of the adsorbent.

### FIELD OF THE ART

The present invention relates to a mercury adsorbent and a process for production thereof. To be more detail, the present invention relates to a mercury adsorbent, made up of sulfur-carried activated carbon, with which sulfur is carried on activated carbon, and exhibiting a sulfur peak top at 534° C. to 537° C. in a calorimetric curve measured by a differential scanning calorimeter at a temperature rise rate of 10° C./minute under a nitrogen atmosphere, and a process for production of the adsorbent. With the mercury adsorbent according to the present invention, mercury or a mercury compound contained in a gas phase of any of various gases, especially exhaust gases, can be adsorbed and removed effectively.

### BACKGROUND ART

Mercury or a mercury compound, which is contained in a gas discharged from a treatment process for fluorescent tubes and other waste that contain mercury, must be removed from standpoints of health and pollution. Conventionally, it is known that sulfur-carried activated carbon adsorbs mercury vapor, and a process for production of sulfur-carried activated carbon by mixing activated carbon and sulfur microparticles and heating the mixture to 110° C. to 400° C. is known (Patent Document 1).
Patent Document 1: Japanese Published Unexamined Patent Application No. Sho 59-78915

Although physical properties of the activated carbon that is a base material, a sulfur amount carried, and a heat treatment temperature are described in Patent Document 1, in regard to the activated carbon, it is only described that just one type of activated carbon with a specific surface area of 1100 m²/g is used as the base material and that the sulfur amount carried per 100 weight parts of the activated carbon is 10 weight parts in most cases and at the most 14 weight parts, and nothing whatsoever is disclosed beyond the above. The heating temperature is set in a range of 120° C. to 400° C. and hardly any differences are seen in regard to the mercury adsorption performance.

Although in regard to mercury adsorbents and mercury removing processes, an adsorbent, which is for mercury contained in a gas and with which a metal halogen compound is carried along with an organic compound having an —SH group, an —SR group, etc., on activated carbon (Patent Document 2), a process of putting a cation exchange resin having metal ions or a chelate resin having metal ions adsorbed thereon in contact with a mercury-containing gas (Patent Document 3), and a heavy metal adsorbent, with which a compound containing a chelate forming group is bound to activated carbon or other porous substance (Patent Document 4), are also known, all of these have a problem in terms of cost and cannot be said to enable advantageous industrial practice.
Patent Document 2: Japanese Published Unexamined Patent Application No. Sho 62-114632
Patent Document 3: Japanese Published Unexamined Patent Application No. Sho 62-155925
Patent Document 4: Japanese Published Unexamined Patent Application No. 2000-342962

### DISCLOSURE OF THE INVENTION

### Problems to be Solved by the Invention

Thus an object of the present invention is to provide a mercury adsorbent, which is optimized in base activated carbon, sulfur amount carried, and heat treatment conditions and is further improved in mercury adsorption performance and can be put into industrial practice advantageously, and a process for production of the mercury adsorbent.

### Means for Solving the Problem

As a result of diligent examination, the present inventors found that a mercury adsorbent, made up of sulfur-carried activated carbon, with which sulfur is carried on activated carbon, and exhibiting a sulfur peak top at 534° C. to 537° C. in a calorimetric curve measured by a differential scanning calorimeter at a temperature rise rate of 10° C./minute under a nitrogen atmosphere, is a mercury adsorbent that meets the above object and have thereby arrived at the present invention. That is, the present invention provides a mercury adsorbent, made up of sulfur-carried activated carbon, with which sulfur is carried on activated carbon, and exhibiting a sulfur peak top at 534° C. to 537° C. in a calorimetric curve measured by a differential scanning calorimeter at a temperature rise rate of 10° C./minute under a nitrogen atmosphere.

Such a mercury adsorbent can be produced favorably when a toluene adsorptivity of the activated carbon that is to be the base material and a sulfur amount carried satisfy a specific relationship. That is, another aspect of the present invention provides a process for production of a mercury adsorbent, where, with respect to 100 weight parts of activated carbon having a toluene adsorptivity (T) in a range of 35 to 70 weight %, sulfur is made to be carried at a sulfur amount carried (S) of a weight part range expressed by a relationship formula: 1.5T−15≧S≧0.3T+10, and heat treatment at 300 to 440° C. is performed.

### Effect(s) of the Invention

With the present invention, a mercury adsorbent that is improved in mercury adsorption performance and can be put into industrial practice advantageously, and a process for production of the adsorbent can be provided. The mercury adsorbent according to the present invention is high in mercury adsorption performance and is capable of efficient and long-term removal of mercury and mercury compounds contained in air, nitrogen, combustion gases, exhaust gases discharged from industrial waste treatment processes, natural gases, petroleum gases, etc.

### BEST MODE(S) FOR CARRYING OUT THE INVENTION

As a raw material of activated carbon used in the present invention, any of normally-used activated carbon raw materials, including plant-based raw materials, such as coconut shell, palm nut shell, peach seed, etc., coal-based raw materials, such as peat, peat briquette, bituminous coal, anthracite coal, etc., synthetic-resin-based raw materials, such as phenol resin, acrylic resin, etc., may be used. Among the above, coconut shell and palm nut shell are preferable, and coconut shell is more preferable.

The raw material of activated carbon is activated to be made into activated carbon, and a process for activation is not restricted in particular, and activated carbon, activated by an oxidizing gas, such as steam, carbon dioxide, etc., or a chemical, such as zinc chloride, phosphoric acid, potassium hydroxide, etc., may be used. Among these, activated carbon activated by steam or carbon dioxide is more preferable. It is preferable to perform acid washing of the activated carbon after activation.

Although the activated carbon may be of any shape, such as crushed, granular, spherical, cylindrical, honeycomb-like, fibrous, etc., activated carbon that is crushed, granular, spherical, or cylindrical is preferable in terms of air flow resistance and economy, and a grain size of the activated carbon is preferably 0.1 to 9 mm. The grain size is more preferably 0.2 mm to 4 mm and even more preferably 0.5 to 3 mm.

In terms of powdering, activated carbon that is hard is preferable, and use of activated carbon with a hardness no less than 97% is preferable in terms of practical use. In the present invention, the hardness of activated carbon can be measured in compliance with JIS K1424.

To make activated carbon carry sulfur, for example, (1) a process of suspending sulfur powder in water, mixing and stirring upon adding the activated carbon, and then drying may be employed. Although the form of sulfur in this process is not restricted in particular, a grain size of the sulfur powder is preferably no more than 0.2 mm and more preferably no more than 0.1 mm.

Also, (2) a process of impregnating the activated carbon with water in advance, thereafter adding and coating with the powdered sulfur, and further adding water and making sulfur strongly adhered to the activated carbon may be employed, and although the form of sulfur is not restricted in particular in this process as well, the grain size of the sulfur powder is preferably no more than 0.2 mm and more preferably no more than 0.1 mm.

Further, in a case of (3) a process where the activated carbon is impregnated with a sulfur solution, in which sulfur is dissolved in carbon disulfide or other solvent, and the solvent is thereafter vaporized, the form of sulfur is not restricted in particular. With (4) a process of mixing hydrogen sulfide gas with sulfur dioxide gas or air and making the gas contact the activated carbon to form sulfur on a porous surface of the activated carbon, sulfur is formed directly on the porous surface of the activated carbon from the sulfur compound gas and the form of sulfur is thus irrelevant.

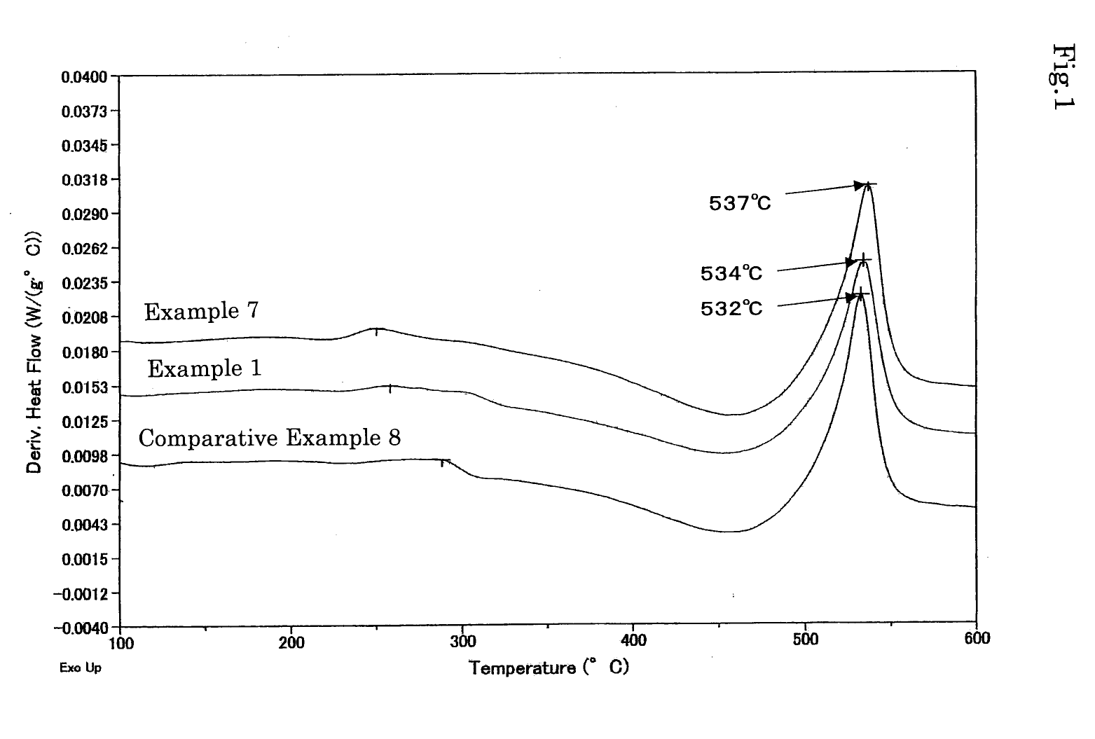

As shown in FIG. 1, to be described below, with the mercury adsorbent of the present invention, a sulfur peak, which is normally present near 445° C., is present at 534° C. to 537° C. in a calorimetric curve measured by a differential scanning calorimeter at a temperature rise rate of 10° C./minute under a nitrogen atmosphere. Although the reason for this cannot necessarily be explained clearly, it is presumed that in the mercury adsorbent according to the present invention, sulfur is carried even in interiors of pores of the activated carbon so that a peak of the sulfur that desorbs from the mercury adsorbent appears belatedly, and by the sulfur being carried even in the interiors of the pores of the activated carbon, an excellent mercury adsorption ability is expressed.

With the base activated carbon, it is effective to promote activation so that a large amount of sulfur can be carried. However, too much activation lowers packing density and hardness, and thus with the present invention, sulfur is preferably carried on activated carbon with a toluene adsorptivity (T), which is an adsorption amount measured in toluene vapor diluted by 10 times at 25° C., in a range of 35 to 70 weight % in compliance to the supplemental edition of JIS K1474 (1999). With a toluene adsorptivity of less than 35 weight %, the sulfur amount carried may be inadequate, and when the toluene adsorptivity exceeds 70 weight, the packing density and strength may decrease.

The amount of sulfur carried (S) on the activated carbon is in a close relationship with the toluene adsorptivity (T), which is a performance index of activated carbon, and as a characteristic of the present invention, it was found that a sulfur amount that is too low or too high is unsatisfactory and an appropriate amount exists. In the present invention, preferably with respect to 100 weight parts of activated carbon having a toluene adsorptivity (T) in a range of 35 to 70 weight, sulfur is made to be carried at a sulfur amount carried (S) of a weight part range expressed by a relationship formula: 1.5T−15≧S≧0.3T+10. More preferably the toluene adsorptivity (T) is in a range of 45 to 60 weight % and sulfur is carried at a sulfur amount carried (S) of a weight part range expressed by a relationship formula: 1.5T−22≧S≧0.3T+20.

Conditions of heat treatment after making sulfur be carried on the activated carbon are also important, and because at a temperature that is too high, not only does the carred amount become unstable due to vaporization of sulfur but it is also dangerous, the heat treatment is preferably performed at 300 to 440° C. and more preferably 320 to 360° C. under nitrogen or under a gas atmosphere with an oxygen concentration of no more than 3 volume % in the present invention. The heat treatment is preferably maintained for at least 10 minutes or more and more preferably maintained for no less than 30 minutes.

With the present invention, a process, where, with respect to 100 weight parts of activated carbon having a toluene adsorptivity (T) in a range of 45 to 60 weight %, With the present invention, a process, where, with respect to 100 weight parts of activated carbon having a toluene adsorptivity (T) in a range of 45 to 60 weight %, a sulfur amount carried (S) is in a weight part range expressed by a relationship formula: 1.5T−22≧S≧0.3T+20 and sulfur is made to be carried, and heat treatment at 320 to 360° C. is performed, is a more preferable production process.

In terms of safety, cooling after the heat treatment is preferably performed under an oxygen concentration of no more than 5 volume % and more preferably under a nitrogen atmosphere.

The mercury adsorbent that is obtained is applied to adsorption of mercury or a mercury compound in a gas phase. Specifically, the invention can be put into practice by packing a packed tower with the mercury adsorbent and passing through air, nitrogen, a noble gas, any of various exhaust gases, a natural gas, or a petroleum gas, etc., containing metal mercury or an inorganic mercury compound, preferably at no more than 80° C. and more preferably at no more than 60° C. Although in this case, a contact time depends on a particle diameter of the adsorbent, as a guideline, it is normally no less than 1 second and preferably no less than 2 seconds. Although the present invention shall now be described by way of examples, the present invention is not restricted to these examples.

Preparation of base activated carbon 500 g of coconut shell activated carbon (KURARAY COAL GG10/20), made by Kuraray Chemicals, Co., Ltd., were loaded into an externally-heated, fluidized-bed activation furnace with a diameter of 100 mm, and after activation for 30 minutes under an LPG combustion gas atmosphere at 880° C., the activated carbon was taken out and cooled in an inert gas. The activated product was crushed by a roll mill and sieved to 0.5 to 1.0 mm as base activated carbon 1. The toluene adsorptivity of the activated carbon was 38 weight %. Activation under the same conditions was performed for 60, 110, and 140 minutes to produce base activated carbons 2 to 4. The toluene adsorptivities were 50, 65, and 73 weight %, respectively. GG10/20 prior to activation was also crushed by a roll mill and sieved to 0.5 to 1.0 mm as base activated carbon 0. The toluene adsorptivity of this activated carbon was 32 weight %.

A coal-based granulated carbon (KURARAY COAL 2GK), made by Kuraray Chemicals Co., Ltd., was crushed by a roll mill and sieved to 0.5 to 1.0 mm as base activated carbon 5. The toluene adsorptivity of this activated carbon was 48 weight %. Results of measuring the toluene adsorptivity, packing density, and hardness of the base activated carbons 0 to 5 are shown together in Table 1. The measurements of packing density and hardness were made in compliance to JIS K1474 (1991).

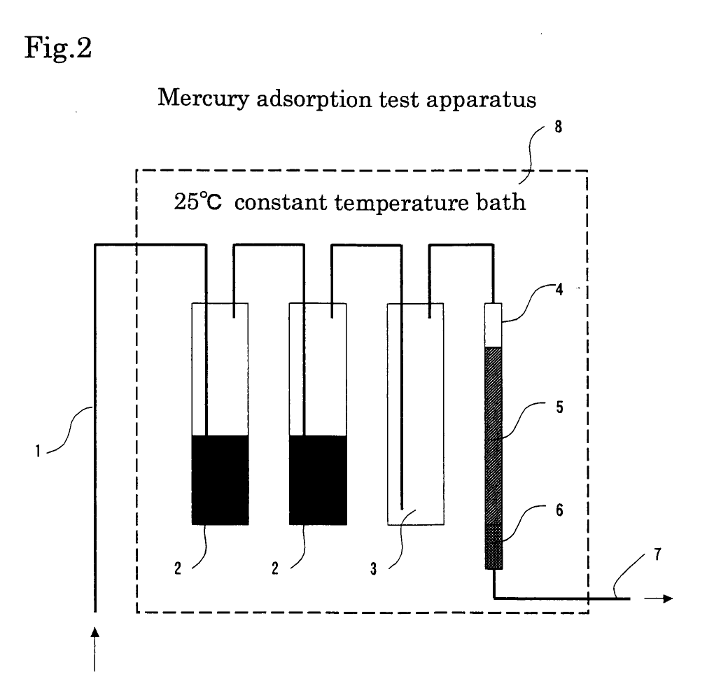

Test of mercury adsorption ability Using a test apparatus such as shown in FIG. 2, 1.000 g of sulfur-carred carbon, with the grain size being adjusted to 0.5 to 1.0 mm in advance, was packed as the mercury adsorbent (5) in a glass column (4) of 6 mm diameter, and an adsorption amount was determined as a weight increase when nitrogen gas (1), containing a mercury-saturated vapor at 25° C., was passed through for 24 hours at rate of 1.00 N1/minute. In FIGS. 1 and 2 denote mercury, 3 denotes an empty bottle, 6 denotes glass wool, 7 denotes exhaust, and 8 is a constant temperature bath. The concentration of the mercury vapor contained in the nitrogen was determined by wet absorption-reduction vaporization atomic absorption spectrometry as described in Japan LPG Association Standards—Analysis Method for Mercury in LP Gas (JLPGA-S-07) to be 2.3 ppm and approximately equal to the mercury saturation concentration at 25° C.

Method of measuring the peak of the temperature of sulfur desorption from mercury adsorbent by differential scanning calorimeter

The peak of the temperature of sulfur desorption from mercury adsorbent was measured using a differential scanning calorimeter (Thermo Plus TG8120), made by Rigaku Corporation, at a temperature rise rate of 10° C./minute under a nitrogen atmosphere. Calorimetric curves of the respective examples are similar and thus the curves of Example 1, Example 8, and Comparative Example 8 are shown as representatives.

### Example 1

A sulfur suspension, with which 40 g of powdered sulfur of not more than 45 μm were dispersed in 95 g of water, was added to and mixed with 100 g of the base activated carbon 1 to coat the powdered sulfur on the activated carbon surface and thereafter, drying was performed for 120 minutes in a dryer set at 120±5° C. The activated carbon was then placed in an externally-heated heating furnace and heated for 40 minutes at 300° C. while making nitrogen flow at a rate of 200 ml/minute. While continuing to make nitrogen flow, the heating furnace was cooled to no higher than 100° C., and the activated carbon was taken out as sulfur-carried carbon No. 1-1. The actually carried sulfur amount determined from weight increase was 39.5 g. The peak of the temperature of sulfur desorption from the mercury adsorbent as measured by the differential scanning calorimeter was exhibited at 534° C. The results are shown in Table 2 and FIG. 1.

### Example 2

Except for using a sulfur suspension with which 30 g of powdered sulfur of not more than 150 μm were dispersed in 95 g of water and heating for 40 minutes at 360° C., sulfur-carried carbon No. 1-2 was produced in the same manner as in Example 1. The actually carried sulfur amount determined from weight increase was 29.6 g. The peak of the temperature of sulfur desorption from the mercury adsorbent as measured by the differential scanning calorimeter was exhibited at 536° C. The results are shown in Table 2.

### Example 3

Except for using the base activated carbon 2, using a sulfur suspension with which 60 g of powdered sulfur of not more than 45 μm were dispersed in 100 g of water, and heating for 20 minutes at 440° C., sulfur-carried carbon No. 2-1 was produced in the same manner as in Example 1. The actually carried sulfur amount determined from weight increase was 57.1 g. The peak of the temperature of sulfur desorption from the mercury adsorbent as measured by the differential scanning calorimeter was exhibited at 537° C. The results are shown in Table 2.

### Example 4

Except for using a sulfur suspension with which 45 g of powdered sulfur of not more than 45 μm were dispersed in 100 g of water and heating for 60 minutes at 330° C., sulfur-carried carbon No. 2-2 was produced in the same manner as in Example 3. The actually carried sulfur amount determined from weight increase was 44.7 g. The peak of the temperature of sulfur desorption from the mercury adsorbent as measured by the differential scanning calorimeter was exhibited at 535° C. The results are shown in Table 2.

### Example 5

Except for using a sulfur suspension with which 38 g of powdered sulfur of not more than 45 μm were dispersed in 100 g of water and heating for 30 minutes at 360° C., sulfur-carried carbon No. 2-3 was produced in the same manner as in Example 3. The actual sulfur amount carried determined from weight increase was 37.4 g. The measurement result of the peak of the temperature of sulfur desorption from the mercury adsorbent as measured by the differential scanning calorimeter was 536° C. The results are shown in Table 2.

### Example 6

Except for using the base activated carbon 3, using a sulfur suspension with which 75 g of powdered sulfur of not more than 45 μm were dispersed in 105 g of water, and heating for 40 minutes at 330° C., sulfur-carried carbon No. 3-1 was produced in the same manner as in Example 1. The actually carried sulfur amount determined from weight increase was 74.1 g. The peak of the temperature of sulfur desorption from the mercury adsorbent as measured by the differential scanning calorimeter was exhibited at 535° C. The results are shown in Table 2.

### Example 7

Except for using a sulfur suspension with which 40 g of powdered sulfur of not more than 45 μm were dispersed in 105 g of water and heating for 30 minutes at 400° C., sulfur-carried carbon No. 3-2 was produced in the same manner as in Example 6. The actually carried sulfur amount determined from weight increase was 38.6 g. The peak of the temperature of sulfur desorption from the mercury adsorbent as measured by the differential scanning calorimeter was exhibited at 537° C. The results are shown in Table 2 and FIG. 1.

### Example 8

100 g of the base activated carbon 3 were added to a solution, with which 35 g of powdered sulfur were dissolved in 100 ml of carbon disulfide, and thereby impregnated with sulfur, and thereafter, the carbon disulfide was purged by drying for 180 minutes under a nitrogen flow in an explosion-proof dryer set at 60±5° C. The sulfur-impregnated activated carbon was placed in an externally-heated heating furnace and heated for 60 minutes at 300° C. while making nitrogen flow at 20 ml/minute. While continuing to make nitrogen, containing 5 volume % of oxygen, flow, the heating furnace was cooled to not more than 100° C., and thereafter the activated carbon was taken out as sulfur-carried carbon No. 3-3. The actually carried sulfur amount determined from weight increase was 34.7 g. The peak of the temperature of sulfur desorption from the mercury adsorbent as measured by the differential scanning calorimeter was exhibited at 534° C. The results are shown in Table 2.

### Example 9

Except for using the base activated carbon 5, using a sulfur suspension with which 34 g of powdered sulfur of not more than 45 μm were dispersed in 105 g of water, and heating for 60 minutes at 330° C., sulfur-carried carbon No. 5-1 was produced in the same manner as in Example 1. The actually carried sulfur amount determined from weight increase was 33.5 g. The peak of the temperature of sulfur desorption from the mercury adsorbent as measured by the differential scanning calorimeter was exhibited at 535° C. The results are shown in Table 2.

### Comparative Example 1

Except for using the base activated carbon 0, using a sulfur suspension with which 40 g of powdered sulfur of not more than 45 μm were dispersed in 86 g of water, and heating for 40 minutes at 250° C., sulfur-carried carbon No. 0-1 was produced in the same manner as in Example 1. The actually carried sulfur amount determined from weight increase was 39.8 g. The peak of the temperature of sulfur desorption from the mercury adsorbent as measured by the differential scanning calorimeter was exhibited at 533° C. The results are shown in Table 2.

### Comparative Example 2

Except for using a sulfur suspension with which 15 g of powdered sulfur of not more than 45 μm were dispersed in 86 g of water and heating for 30 minutes at 300° C., sulfur-carried carbon No. 0-2 was produced in the same manner as in Comparative Example 1. The actually carried sulfur amount determined from weight increase was 14.7 g. The peak of the temperature of sulfur desorption from the mercury adsorbent as measured by the differential scanning calorimeter was exhibited at 534° C. The results are shown in Table 2.

### Comparative Example 3

Except for using the base activated carbon 1, using a sulfur suspension with which 30 g of powdered sulfur of not more than 45 μm were dispersed in 95 g of water, and heating for 40 minutes at 480° C., sulfur-carried carbon No. 1-3 was produced in the same manner as in Comparative Example 1. The actually carried sulfur amount determined from weight increase was 22.0 g. The peak of the temperature of sulfur desorption from the mercury adsorbent as measured by the differential scanning calorimeter was exhibited at 538° C. The results are shown in Table 2.

### Comparative Example 4

Except for using the base activated carbon 2, using a sulfur suspension with which 75 g of powdered sulfur of not more than 45 μm were dispersed in 100 g of water, and heating for 40 minutes at 300° C., sulfur-carried carbon No. 2-4 was produced in the same manner as in Comparative Example 1. The actually carried sulfur amount determined from weight increase was 73.3 g. The peak of the temperature of sulfur desorption from the mercury adsorbent as measured by the differential scanning calorimeter was exhibited at 534° C. The results are shown in Table 2.

### Example 10

Except for using the base activated carbon 4, using a sulfur suspension with which 40 g of powdered sulfur of not more than 45 μm were dispersed in 115 g of water, and heating for 40 minutes at 360° C., sulfur-carried carbon No. 4-1 was produced in the same manner as in Comparative Example 1. The actually carried sulfur amount determined from weight increase was 39.4 g. The peak of the temperature of sulfur desorption from the mercury adsorbent as measured by the differential scanning calorimeter was exhibited at 536° C. The results are shown in Table 2.

### Comparative Example 5

The mercury adsorption performance was measured for the base activated carbon 2 that does not carry sulfur.

### Comparative Example 6

Except for using the base activated carbon 5, using a sulfur suspension with which 21 g of powdered sulfur of not more than 45 μm were dispersed in 100 g of water, and heating for 60 minutes at 330° C., sulfur-carried carbon No. 5-2 was produced in the same manner as in Comparative Example 1. The actually carried sulfur amount determined from weight increase was 20.5 g. The peak of the temperature of sulfur desorption from the mercury adsorbent as measured by the differential scanning calorimeter was exhibited at 535° C. The results are shown in Table 2.

### Comparative Example 7

A sulfur suspension, with which 10.2 g of powdered sulfur of not more than 45 μm were dispersed in 90 ml of water, was added to and mixed with 100 g of a 16- to 32-mesh (0.5 to 1 mm) coconut shell activated carbon (base activated carbon 6) with a BET surface area of 1108 m²/g to uniformly apply the powdered sulfur onto the activated carbon surface, heating was thereafter performed in air at 200° C. for 60 minutes, and the activated carbon was thereafter taken out as sulfur-carried carbon No. 6-1. The actually carried sulfur amount determined from weight increase was 10.0 g. The toluene adsorptivity of the activated carbon of the base material 6 was 34.4 weight %. The peak of the temperature of sulfur desorption from the mercury adsorbent as measured by the differential scanning calorimeter was exhibited at 532° C. The results are shown in Table 2.

### Comparative Example 8

After uniformly spraying 90 ml of water onto 100 g of the same base activated carbon as that used in Comparative Example 8, a sulfur suspension, with which 10.3 g of powdered sulfur of not more than 45 μm were dispersed in 90 ml of water, was added to and mixed with the wetted activated carbon while stirring to uniformly apply the powdered sulfur onto the activated carbon surface, heating was thereafter performed in nitrogen gas at 400° C. for 30 minutes, and the activated carbon was thereafter taken out as sulfur-carried carbon No. 6-2. The actually carried sulfur amount determined from weight increase was 10.0 g. The peak of the temperature of sulfur desorption from the mercury adsorbent as measured by the differential scanning calorimeter was exhibited at 537° C. The results are shown in Table 2.

TABLE 1
Toluene adsorptivity, packing density,
and hardness of base activated carbons

| | Toluene | Packing | |
|---|---|---|---|
| Base activated | adsorptivity | density | Hardness |
| carbon No. | (weight %) | (g/ml) | (%) |
| 0 | 32 | 0.52 | 99.3 |
| 1 | 38 | 0.48 | 99.2 |
| 2 | 52 | 0.41 | 98.6 |
| 3 | 65 | 0.35 | 97.4 |
| 4 | 73 | 0.31 | 96.0 |
| 5 | 50 | 0.38 | 98.0 |
| 6 | 34.4 | 0.51 | 99.0 |

TABLE 2
Mercury adsorption amount measurement results of sulfur-carried carbons

| | | | | | 24-hour value | Sulfur |
|---|---|---|---|---|---|---|
| | Sulfur- | Sulfur | | Heating | of mercury | desorption |
| | carried | carried | 1.5 T − 15 ≧ | temperature | adsorption | temperature |
| | carbon No. | amount (g) | S ≧ 0.3 T + 1 | 300 to 400° C. | amount (mg/g) | peak top (° C.) |
| Example 1 | 1-1 | 39.5 | ∘ | ∘ | 21.3 | 534 |
| Example 2 | 1-2 | 29.6 | ∘ | ∘ | 20.2 | 536 |
| Example 3 | 2-1 | 57.1 | ∘ | ∘ | 22.8 | 537 |
| Example 4 | 2-2 | 44.7 | ∘ | ∘ | 27.2 | 535 |
| Example 5 | 2-3 | 29.4 | ∘ | ∘ | 25.8 | 536 |
| Example 6 | 3-1 | 74.1 | ∘ | ∘ | 23.8 | 535 |
| Example 7 | 3-2 | 33.6 | ∘ | ∘ | 25.3 | 537 |
| Example 8 | 3-3 | 34.7 | ∘ | ∘ | 24.2 | 534 |
| Example 9 | 5-1 | 25.1 | ∘ | ∘ | 23.1 | 535 |
| Comparative | 0-1 | 39.8 | x | x | 11.5 | 533 |
| Example 1 | | | | | | |
| Comparative | 0-2 | 14.7 | x | x | 8.6 | 534 |
| Example 2 | | | | | | |
| Comparative | 1-3 | 22.0 | ∘ | x | 16.5 | 538 |
| Example 3 | | | | | | |
| Comparative | 2-4 | 73.3 | x | ∘ | 18.1 | 534 |
| Example 4 | | | | | | |
| Example | 4-1 | 39.4 | ∘ | ∘ | 21.8 | 536 |
| Comparative | 0-0 | 0 | x | x | 0.3 | — |
| Example 5 | | | | | | |
| Comparative | 5-2 | 20.5 | x | ∘ | 13.4 | 535 |
| Example 6 | | | | | | |
| Comparative | 6-1 | 10.0 | x | x | 9.2 | 532 |
| Example 7 | | | | | | |
| Comparative | 6-2 | 10.0 | x | ∘ | 10.1 | 537 |
| Example 8 | | | | | | |

It can be understood that whereas with all of the sulfur-carried carbons of Examples 1 to 9 according to the present invention, the 24-hour value of the mercury adsorption amount was not less than 20 mg/g, Comparative Examples 1 to 5 exhibited values of less than 20 mg/g and are poorer in mercury adsorption ability. Comparative Example 5, which is high in toluene adsorptivity, satisfies the adsorption performance but is insufficient in hardness and thus has problems in terms of practical use, such as in regard to powdering, etc. Comparative Example 6 is base activated carbon that does not carry sulfur and hardly exhibits any mercury adsorption performance.

### INDUSTRIAL APPLICABILITY

The mercury adsorbent according to the present invention is high in mercury adsorption performance, is capable of efficient and long-term removal of mercury and mercury compounds, contained in air, nitrogen, combustion gases, exhaust gases discharged from industrial waste treatment processes, natural gases, petroleum gases, etc., and is thus useful industrially.

### BRIEF DESCRIPTION OF THE DRAWINGS

[FIG. 1] shows calorimetric curves of mercury adsorbents obtained in Example 1, Example 7, and Comparative Example 8.

[FIG. 2] is a schematic view of a mercury adsorption ability test apparatus.

### DESCRIPTION OF THE SYMBOLS

1 Nitrogen gas

2 Mercury

3 Empty bottle

4 Column

5 Adsorbent

6 Glass wool

7 Exhaust

8 Constant temperature bath

1-7. (canceled)

8. A mercury adsorbent comprising sulfur-carried activated carbon, wherein sulfur is carried on activated carbon by causing sulfur to be carried at a sulfur amount carried (S) of a weight part range expressed by the relationship formula: 1.5T−15≧S≧0.3T+10 with respect to 100 weight parts of activated carbon having a toluence adsorptivity (T) in a range of 35 to 70 weight % and performing a heat treatment at 300 to 440° C., said absorbent exhibiting a sulfur peak top of the temperature of sulfur desorption at 534° C. to 537° C. in a calorimetric curve measured by a differential scanning calorimeter at a temperature rise rate of 10° C./minute under a nitrogen atmosphere.

9. The mercury adsorbent according to claim 8, wherein a hardness of the activated carbon is not less than 97%.

10. The mercury adsorbent according to claim 8, wherein the activated carbon is activated carbon having coconut shell carbon as a raw material.

11. The mercury adsorbent according to claim 8, wherein a grain size of the activated carbon is 0.1 to 9 mm.

12. A process for production of a mercury adsorbent, wherein, with respect to 100 weight parts of activated carbon having a toluene adsorptivity (T) in a range of 35 to 70 weight %, causing sulfur to be carried at a sulfur amount carried (S) of a weight part range expressed by a relationship formula: 1.5T−15≧S≧0.3T+10, and performing a heat treatment at 300 to 440° C.

13. The process for production of a mercury adsorbent according to claim 12, wherein the toluene adsorptivity (T) is in a range of 45 to 60 weight % and the sulfur amount carried (S) is expressed by the relationship formula: 1.5T−22≧S≧0.3T+20.

14. The process for production of a mercury adsorbent according to claim 12, wherein the temperature of heat treatment is 320 to 360° C.
